(19) United States
(12) Patent Application Publication
(10) Pub. No.: US 2020/0201990 A1
(43) Pub. Date: Jun. 25, 2020

(54) DATA CONTROL SYSTEM, DATA CONTROL METHOD, AND DATA CONTROL PROGRAM

(71) Applicant: NEC Corporation, Tokyo (JP)

(72) Inventors: Ryo HAMAMOTO, Minato-ku, Tokyo (JP); Takayuki SASAKI, Minato-ku, Tokyo (JP)

(73) Assignee: NEC Corporation, Tokyo (JP)

(21) Appl. No.: 16/615,298

(22) PCT Filed: May 26, 2017
(86) PCT No.: PCT/JP2017/019734

§ 371 Date: Nov. 20, 2019

(51) Int. Cl. G06F 21/55; G06F 21/44; G06F 21/56; G06F 21/57; G06F 21/71

(52) U.S. Cl. CPC G06F 21/554; G06F 21/44; G06F 21/71; G06F 21/563; G06F 21/57; G06F 21/566

(57) ABSTRACT

A control system 80 includes a control unit 81 that controls transmission of data from a source to a destination. The control unit 81 controls transmission of data to a destination based on a distribution history of transmission data.

### TECHNICAL FIELD

The present invention relates to a data control system, a data control method, and a data control program which control data transmission.

### BACKGROUND ART

In a large number of systems connected through communication networks, various processes are performed by exchanging data. For example, in an urban system, such as a smart city, various processes are performed on various data generated by various things.

In such a system, data handling is very important. Therefore, it is necessary to control a process to be performed depending on the type of data. For example, data relating to Individual Number (Social Security and Tax Number) is preferably handled not to be stored, and access to the Individual Number is preferably limited to a specific user. Therefore, it is necessary to determine whether data can be passed to specific control (e.g., an application), depending on the type of data.

As a method of performing such control, a method is known to set permission or denial of access for each user. For example, when “POST” operation is to be permitted for users “Alice” and “Bob”, a policy indicating whether access is permitted is preferably set for each user.

Furthermore, PTL 1 describes a resource protection processing method for protecting a resource processed by a computer. In the method described in PTL 1, a process for controlling predetermined access to a predetermined resource is defined as a defined action. Then, upon actual access to the actual resource, a defined action associated with an actual state transition history is selected and the selected defined action is performed.

### CITATION LIST

### Patent Literature

PTL 1: Japanese Patent Application Laid-Open No. 2012-137938

### SUMMARY OF INVENTION

### Technical Problem

In an environment in which there are malicious applications and systems, it is important not to send data not having passed through high-security applications that perform anonymization or encryption, to other applications.

However, for example, even if a POST destination is a malicious application, such a method for setting permission or denial of access for each user, as described above, cannot control access to such a malicious application. Therefore, there is a problem that data which should not be transmitted is transmitted only with such a method.

For example, even if a system partially using an Individual Number (Social Security and Tax Number) achieves access control only based on user information, it is difficult to detect that the destination of the Individual Number (Social Security and Tax Number) is a database (application performing a process of storing data).

Furthermore, the method described in PTL 1 controls the access to a resource based on an operation history of a single program. Therefore, even if the method described in PTL 1 is used, safe distribution of data is difficult.

Therefore, an object of the present invention is to provide a data control system, a data control method, and a data control program which are capable of controlling data to be safely distributed.

### Solution to Problem

A data control system according to the present invention includes a control unit that controls transmission of data from a source to a destination, in which the control unit controls transmission of data to the destination based on a distribution history of transmission data.

A data control method according to the present invention includes controlling transmission of data from a source to a destination based on a distribution history of transmission data.

A data control program according to the present invention causes a computer to perform a control process of controlling transmission of data from a source to a destination, and controlling the transmission of data to the destination based on a distribution history of transmission data.

### Advantageous Effects of Invention

According to the present invention, it is possible to control data to be safely distributed.

### BRIEF DESCRIPTION OF DRAWINGS

FIG. 1 It depicts a block diagram illustrating a configuration example of a data control system according to a first exemplary embodiment of the present invention.

FIG. 2 It depicts a table illustrating an example of a log.

FIG. 3 It depicts tables illustrating examples of access policies.

FIG. 4 It depicts a table illustrating another example of the access policy.

FIG. 5 It depicts an explanatory diagram illustrating an example of a process of generating a state transition diagram from an access policy.

FIG. 6 It depicts an explanatory diagram illustrating an example of a process of determining whether to permit data transmission.

FIG. 7 It depicts a flowchart illustrating an operation example of a data control system according to a first exemplary embodiment.

FIG. 8 It depicts a block diagram illustrating a configuration example of a data control system according to a second exemplary embodiment of the present invention.

FIG. 9 It depicts an explanatory diagram illustrating an example of a process of determining whether to permit data transmission.

FIG. 10 It depicts a flowchart illustrating an operation example of a data control system according to a second exemplary embodiment.

FIG. 11 It depicts a block diagram illustrating a configuration example of a data control system according to a third exemplary embodiment of the present invention.

FIG. 12 It depicts a flowchart illustrating an operation example of a data control system according to the third exemplary embodiment.

FIG. 13 It depicts a block diagram illustrating an outline of a data control system according to the present invention.

### DESCRIPTION OF EMBODIMENTS

Exemplary embodiments of the present invention will be described below with reference to the drawings. In the present invention, access control is achieved in consideration of a series of histories (hereinafter, referred to as a distribution history of data) generated in data distribution. The distribution history of data represents a series of histories associated with certain data and includes not only a history of the certain data itself, but also a history of data from which the certain data is generated and a history of data generated based on the certain data.

In other words, in the present exemplary embodiment, combined/divided data are collectively managed as one distribution history. Examples of combining or dividing data include generation of other data from a plurality of blocks of data, transmission of data to different applications, and the like. Specifically, the distribution history includes data generation time, a user device system from which the data is generated, data forward information, and the like.

In the following description, a system component element, such as a source from which data is generated, an application through which data passes, or a destination in which the data is stored may be also referred to as a component.

### EXEMPLARY EMBODIMENT 1

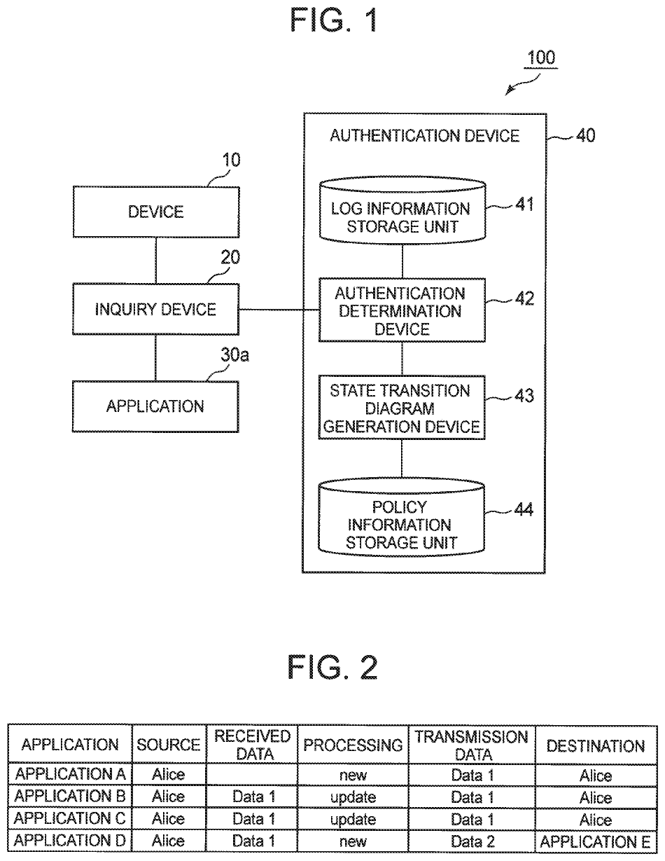

FIG. 1 is a block diagram illustrating a configuration example of a data control system according to a first exemplary embodiment of the present invention. A data control system 100 according to the present exemplary embodiment includes a device 10, an inquiry device 20, an application 30a, and an authentication device 40.

The device 10 transmits transmission data to the application 30a to the inquiry device 20. In other words, the device 10 makes a request for the inquiry device 20 to determine whether data can be transmitted to the application 30a. The device 10 may be a single device or part of another system (not illustrated). Furthermore, the device 10 may be a device that operates in response to a user's instruction.

Data transmitted by the device 10 is data used for processing by the application 30a and specific example thereof includes an Individual Number (Social Security and Tax Number) and the like.

The inquiry device 20 receives information indicating a destination (specifically, the application 30a) of the data together with the data, from the device 10 that is a source. Then, the inquiry device 20 inquires of the authentication device 40 whether the received data can be transmitted to the destination.

Specifically, the inquiry device 20 transmits information that can identify the received data and information on the destination to the authentication device 40. In addition, the inquiry device 20 may transmit other metadata, such as an ID of a data sender, information indicating the presence/absence or the like of personal information, or an inquiry number from the inquiry device, to the authentication device 40.

The inquiry device 20 determines whether transmission to the destination is permitted, according to a result of the determination from the authentication device 40 which is described later. When determining to permit the transmission, the inquiry device 20 transmits the data received from the device 10 to the application 30a. On the other hand, when determining not to permit the transmission, the inquiry device 20 does not transmit the data received from the device 10 to the application 30a. In this case, the inquiry device 20 may discard the received data or may transmit, to the device 10, a response indicating that transmission is not permitted.

The application 30a is a component that receives data from the device 10. In the present exemplary embodiment, the case where the component as a destination is an application is exemplified, but the destination is not limited to the application and may be, for example, a database or a storage device.

The authentication device 40 includes a log information storage unit 41, an authentication determination device 42, a state transition diagram generation device 43, and a policy information storage unit 44.

The log information storage unit 41 stores a distribution history of data as a log. The distribution history of data is created by each component upon generation, edit, update, deletion, transfer, or the like of data by each component and stored in the log information storage unit 41.

Note that a component (not illustrated) that generates a distribution history may collectively create a distribution history and store the created distribution history in the log information storage unit 41.

FIG. 2 is a table illustrating an example of a log stored in the log information storage unit 41. The example illustrated in FIG. 2 shows that the log includes a source of data, the contents of the data received, processing performed, the contents of transmission data, and a destination of the data.

For example, FIG. 2 shows that an application A newly generates Data 1 in response to an instruction from Alice and returns Data 1 to Alice. Here, Data 1 does not indicate a value of the data itself but is information that can identify the data, such as a location storing the data.

Likewise, FIG. 2 shows that an application B updates Data 1 transmitted from Alice and returns Data 1 to Alice, and an application C updates Data 1 transmitted from Alice and returns Data 1 to Alice. Furthermore, FIG. 2 shows that an application D newly creates Data 2 from Data 1 transmitted from Alice and returns Data 2 to an application E.

In the present exemplary embodiment, the configuration in which the authentication device 40 includes the log information storage unit 41 is exemplified, but the authentication device 40 may not include the log information storage unit 41 and receive log information (distribution history) from an external device (not illustrated) connected. Alternatively, a configuration may be provided in which data itself is caused to hold data log information (distribution history) as metadata, and the authentication device 40 receives the data.

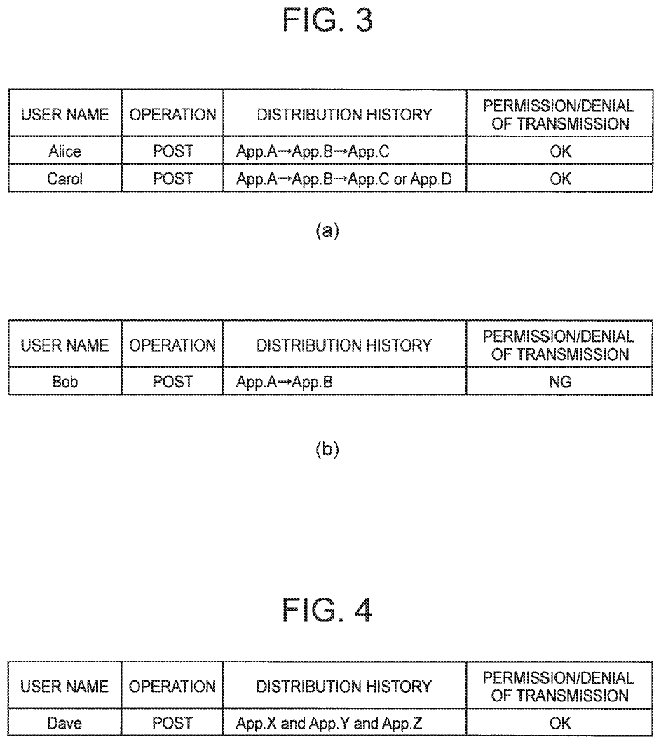

The policy information storage unit 44 stores an access policy that defines whether transmission to a destination can be performed for a distribution history. FIG. 3 is tables illustrating examples of access policies. In the examples illustrated in FIG. 3, each of the access policies is set for each user.

In the example illustrated in FIG. 3(a), when there is an access policy including a defined distribution history, transmission to a destination is permitted, and otherwise, transmission is not permitted. For example, when the application C is an application that performs encryption processing, passing through the application C is considered to be necessary for permission of transmission. The example of an access policy for Alice illustrated in FIG. 3(a) shows that when a distribution history of data to be transmitted includes a history of the data passing through the application A, the application B, and the application C in this order, POST operation is permitted.

Furthermore, a distribution history to be permitted may be selectively defined in the access policy. The example of an access policy for Carol illustrated in FIG. 3(a) shows that when a distribution history of data to be transmitted includes a history of the data passing through any of the application C and the application D after passing through the application A and the application B in this order, POST operation is permitted.

Note that transmission to a destination may be permitted, excluding transmission made when there is an access policy including a defined distribution history. The example of an access policy for Bob illustrated in FIG. 3(b) shows that when a distribution history of data to be transmitted includes a history of the data passing through the application A and the application B in this order, the POST operation is not permitted, and otherwise, the POST operation is permitted.

In FIG. 3, POST in hypertext transfer protocol (HTTP) is illustrated as an example of a transmission operation, but a transmission operation to be permitted is not limited to POST and may be, for example, GET.

Note that FIG. 3 illustrates an example in which one-way flow of data or branching of data is defined in the access policy. In addition, permission or denial of transmission for the distribution history indicating that data is generated based on outputs from a plurality of components (i.e., merging flows of data) may be defined in the access policy.

FIG. 4 is a table illustrating another example of the access policy. The example of an access policy for Dave illustrated in FIG. 4 shows permission or denial of transmission is defined for a distribution history indicating that data to be transmitted is generated based on outputs from three applications X, Y, and Z. This applies to a case, for example, where the applications X, Y, and Z are each an application that outputs a value detected by a sensor, and a destination application is an application that can perform processing when all of the values.

FIGS. 3 and 4 each illustrate the example of the access policy that is set for each user, but a unit by which the access policy is set is not limited to each user. The access policy may be set for each group of users or may be set for the whole of users.

The state transition diagram generation device 43 generates an automaton from the access policy. Examples of the automata include a state transition diagram and a state transition table. In a case where the access policy is represented by a kind of regular expression, when the state transition diagram generation device 43 generates an automaton from the access policy, a problem for which the authentication determination device 42, described later, determines whether to perform authentication can be resulted in a search problem on the automaton (graph).

Hereinafter, for ease of explanation, an automaton which is generated as a state transition diagram will be described as an example. Note that when the access policy has already been expressed by the automaton, the authentication device 40 may not include the state transition diagram generation device 43.

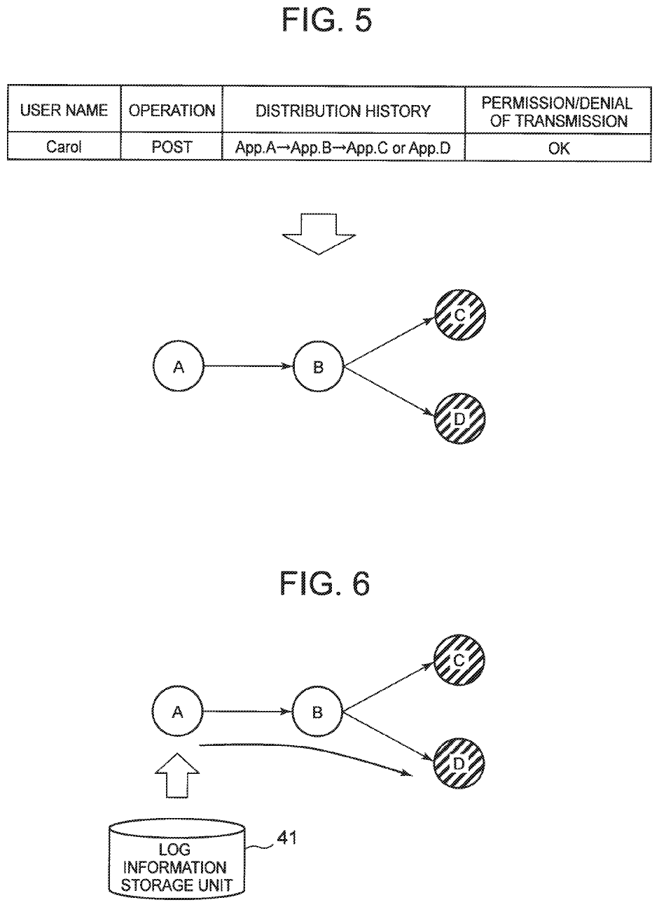

FIG. 5 is an explanatory diagram illustrating an example of a process of generating a state transition diagram from an access policy. In the state transition diagram illustrated in FIG. 5, each of component elements represented by circles (◯) corresponds to a component. Note that the example of the state transition diagram illustrated in FIG. 5 indicates that when there is an access policy including a defined distribution history, transmission to a destination is permitted, and otherwise, transmission is not permitted.

Of the components illustrated in FIG. 5, a shaded circle (hereinafter also referred to as an “accepted state”) represents that performance of operation requested for data is permitted. On the other hand, a white circle (hereinafter also referred to as a “non-accepted” state) represents that performance of operation requested for data is not permitted.

The example illustrated in FIG. 5 indicates that the state transition diagram generation device 43 has generated a branching automaton based on a distribution history indicated by the access policy for Carol.

Note that the example of the state transition diagram illustrated in FIG. 5 indicates that when there is an access policy including a defined distribution history, transmission to a destination is not permitted, and otherwise, transmission is permitted. In this case, the shaded circles represent that an operation requested for the data is not permitted, and the white circles represents that an operation requested for the data is permitted.

Note that the access policy as illustrated in FIGS. 3 and 4 can be regarded as a kind of regular expression. Furthermore, since an algorithm for converting a regular expression into an automaton is widely known, detailed description thereof will be omitted herein. Furthermore, it is also conceivable that the number of automata increases by the number of access policies. In this regard, an automaton state optimization algorithm is also known, and a certain number of states can be reduced.

The authentication determination device 42 determines whether to transmit the data, from a distribution history of transmission data, based on an access policy. Specifically, the authentication determination device 42 identifies a distribution history of data received from the inquiry device 20, from the log information storage unit 41. Note that in a case where the data itself is caused to hold data log information as metadata, the authentication determination device 42 may specify the distribution history of data from the log information. The authentication determination device 42 determines whether to transmit data, based on whether the identified distribution history of data includes a distribution history matching the access policy.

In a case where an access policy is expressed by an automaton as described in the present exemplary embodiment, the authentication determination device 42 traces the automaton (state transition diagram) from an identified distribution history and determines whether a distribution history matching the access policy is included.

For example, it is assumed that transmission to a destination is permitted when an access policy includes a defined distribution history. At this time, when the identified distribution history of data includes a distribution history matching the access policy, the authentication determination device 42 transmits a result of the determination of permitting the transmission of the data, to the inquiry device 20. On the other hand, it is assumed that transmission to a destination is not permitted when an access policy includes a defined distribution history. At this time, when the identified distribution history of data includes a distribution history matching the access policy, the authentication determination device 42 transmits a result of the determination of permitting the transmission of no data, to the inquiry device 20.

FIG. 6 is an explanatory diagram illustrating an example of a process of determining whether to permit data transmission. For example, it is assumed that the state transition diagram illustrated in FIG. 5 has been generated. In this case, the authentication determination device 42 extracts a distribution history of data from the log information storage unit 41 and compares the distribution history with the state transition diagram generated from the access policy. The authentication determination device 42 determines to permit transmission of data when a component is in the acceptance state.

For example, when data has passed through the “application A”→“application B”→“application D”, this distribution history matches the access policy indicated by an arrow in FIG. 6. Therefore, the authentication determination device 42 determines that component is in the acceptance state (application D) and determines that the data transmission is to be permitted.

Furthermore, for example, as illustrated in FIG. 4, it is assumed that the access policy defines permission or denial of transmission for the distribution history indicating that data is generated based on outputs from a plurality of components. At this time, when transmission data is data that has passed through all of the plurality of components defined in the access policy, the authentication determination device 42 may determine to permit the transmission of the data.

From the above, it can be said that the inquiry device 20 and the authentication device 40 according to the present exemplary embodiment operate as a control unit that controls transmission of data from a source to a destination to control transmission of data to a destination based on a distribution history of transmission data.

The inquiry device 20 and the authentication device 40 (more specifically, the authentication determination device 42 and the state transition diagram generation device 43) are achieved by a CPU of a computer that operates according to a program (data control program).

For example, the program is stored in a storage unit (not illustrated) included in the data control system 100, and the CPU may read the program to operate as the inquiry device 20 and the authentication device 40 (more specifically, the authentication determination device 42, and the state transition diagram generation device 43) according to the program.

Furthermore, each of the inquiry device 20 and the authentication device 40 (more specifically, the authentication determination device 42 and the state transition diagram generation device 43) may be achieved by dedicated hardware. Furthermore, the inquiry device 20 and the authentication device 40 may be achieved integrally. Furthermore, the log information storage unit 41 and the policy information storage unit 44 are achieved by a magnetic disk or the like.

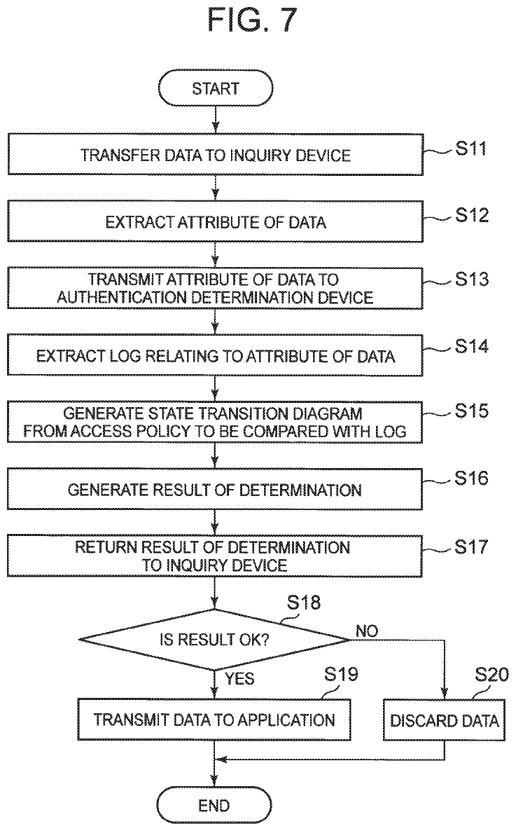

Next, the operation of the data control system according to the present exemplary embodiment will be described. FIG. 7 is a flowchart illustrating an operation example of a data control system 100 according to the first exemplary embodiment. The device 10 transfers data to the inquiry device 20 (step S11). The inquiry device 20 extracts an attribute of the data from the received data (step S12). The inquiry device 20 may extract so-called metadata, such as an identifier of a data sender or the presence/absence or the like of personal information, as the attribute of the data.

The inquiry device 20 transmits the extracted attribute of the data to the authentication determination device 42 in the authentication device 40 (step S13). The authentication determination device 42 extracts a log relating to the received attribute of the data, as a distribution history, from the log information storage unit 41 (step S14). Note that, in step S14, in a case where data itself is caused to hold the log information of the data as the metadata, the authentication determination device 42 may identify the distribution history of the data from the log information.

On the other hand, the state transition diagram generation device 43 generates a state transition diagram from an access policy stored in the policy information storage unit 44. Then, the authentication determination device 42 compares the distribution history with the state transition diagram, and determines whether to transmit the data (step S15). The authentication determination device 42 generates a result of the determination (step S16), and returns the result of the determination to the inquiry device 20 (step S17).

The inquiry device 20 determines the content of the result of the determination (step S18). When the result of the determination represents permission of transmission of the data (Yes in step S18), the inquiry device 20 transmits the data to the application 30a (step S19). On the other hand, when the result of the determination does not represent permission of transmission of the data (No in step S18), the inquiry device 20 discards the data (step S20). In other words, the inquiry device 20 does not transmit the data to the application 30a. Note that, in step S20, the inquiry device 20 may transmit a response indicating that transmission is not permitted to the device 10.

As described above, in the present exemplary embodiment, the inquiry device 20 and the authentication device 40 (authentication determination device 42) control data transmission from the device 10 to the application 30a. Specifically, the authentication determination device 42 controls the transmission of data to the application 30a, based on a distribution history of transmission data. Therefore, it is possible to control data to be safely distributed.

For example, in a general access control method using only information at the time of access to data, it is difficult to perform access control in consideration of changes over time. On the other hand, in the present exemplary embodiment, a series of distribution of data from generation to storage of the data is managed, and whether to transmit the data is determined based on the distribution history. Therefore, it is possible to control data to be safely distributed.

### Exemplary Embodiment 2

Next, a data control system according to a second exemplary embodiment of the present invention will be described. In the first exemplary embodiment, the case where the device 10 has one destination, which is the application 30a, has been described. In the present exemplary embodiment, a description is made on the assumption that a configuration has a plurality of destinations.

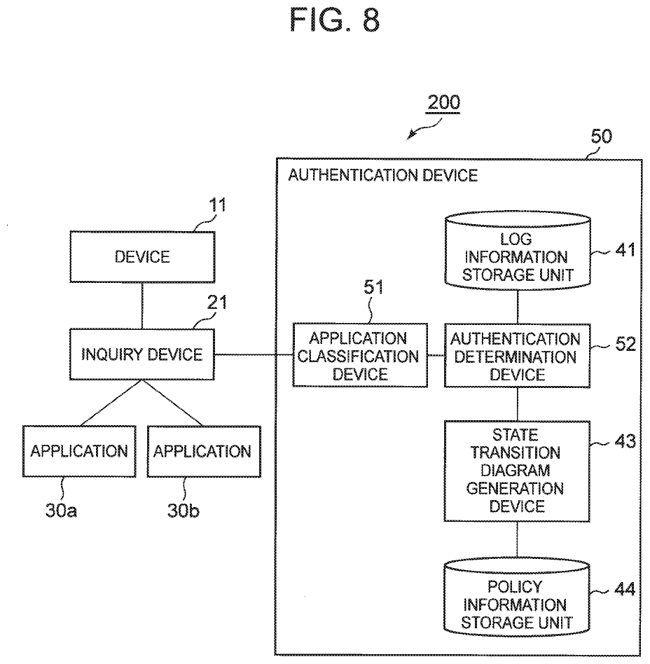

FIG. 8 is a block diagram illustrating a configuration example of the data control system according to the second exemplary embodiment of the present invention. A data control system 200 of the present exemplary embodiment includes a device 11, an inquiry device 21, an application 30a, an application 30b, and an authentication device 50.

The device 11 transmits transmission data to the application 30a and the application 30b to the inquiry device 21. In other words, the device 11 makes a request for the inquiry device 21 to determine whether data can be transmitted to the application 30a and the application 30b. As in the first exemplary embodiment, the device 11 may be a single device or part of another system (not illustrated). Furthermore, the device 11 may be a device that operates in response to a user's instruction.

The inquiry device 21 receives information indicating destinations (specifically, the application 30a and the application 30b) of the data together with the data, from the device 11 that is a source. Then, the inquiry device 21 inquires of the authentication device 50 whether the received data can be transmitted to each destination. Note that the contents of the transmission data at the time of the inquiry are the same as those transmitted by the inquiry device 20 according to the first exemplary embodiment.

The inquiry device 21 determines whether transmission to each of the destinations is permitted according to a result of determination from the authentication device 50 which is described later. The inquiry device 21 may transmit data only to a destination to which transmission of data is determined to be permitted, or may transmit data to all destinations only when permission of transmission of data to all the destinations is determined.

The application 30a and the application 30b are components that receive data from the device 11.

The authentication device 50 includes a log information storage unit 41, an authentication determination device 52, a state transition diagram generation device 43, a policy information storage unit 44, and an application classification device 51. The contents of the log information storage unit 41, the state transition diagram generation device 43, and the policy information storage unit 44 are the same as those in the first exemplary embodiment.

The application classification device 51 notifies the authentication determination device 52 of the attribute of data for each received destination. Furthermore, the application classification device 51 returns a result of determination performed by an authentication determination device 52, which is described later, to the inquiry device 21.

The authentication determination device 52 determines whether to transmit the data for each destination, from a distribution history of transmission data, based on an access policy. Note that a method of determining whether to transmit the data by the authentication determination device 52 is the same as the method performed by the authentication determination device 42 according to the first exemplary embodiment. The authentication determination device 52 notifies the application classification device 51 of a result of the determination.

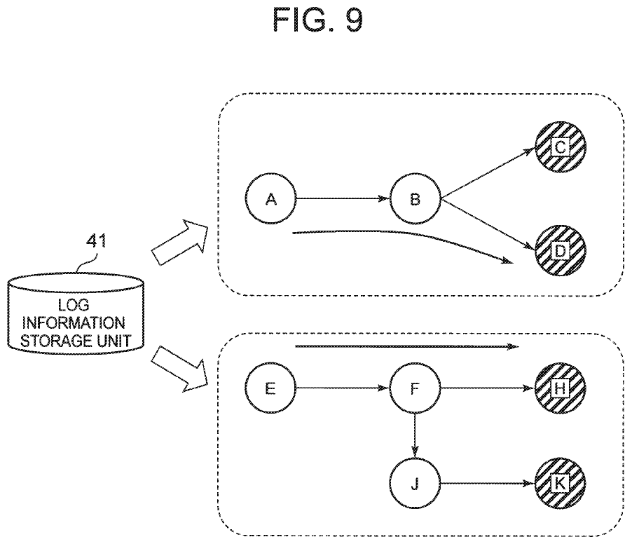

FIG. 9 is an explanatory diagram illustrating an example of a process of determining whether to permit data transmission. Each of the ranges surrounded by a broken line illustrated in FIG. 9 represents an access policy for each application. For example, as illustrated in FIG. 9, it is assumed that a state transition diagram corresponding to an access policy associated with each application is generated. In this case, the authentication determination device 52 extracts a distribution history of data from the log information storage unit 41 for each application and compares the distribution history with the state transition diagram generated from each access policy. As in the example illustrated in FIG. 6, when a component is in the acceptance state, the authentication determination device 52 determines to permit transmission of data.

Then, when the application classification device 51 transmits each result of the determination to the inquiry device 21, the inquiry device 21 determines whether to permit transmission of the data to the destination according to the received result. As described above, the inquiry device 21 may transmit data only to a destination to which transmission of data is determined to be permitted, or may transmit data to all destination only when permission of transmission of data to all the destinations is determined.

Note that the inquiry device 21 and the authentication device 50 (more specifically, the application classification device 51, the authentication determination device 52, and the state transition diagram generation device 43) are achieved by a CPU of a computer that operates according to a program (data control program).

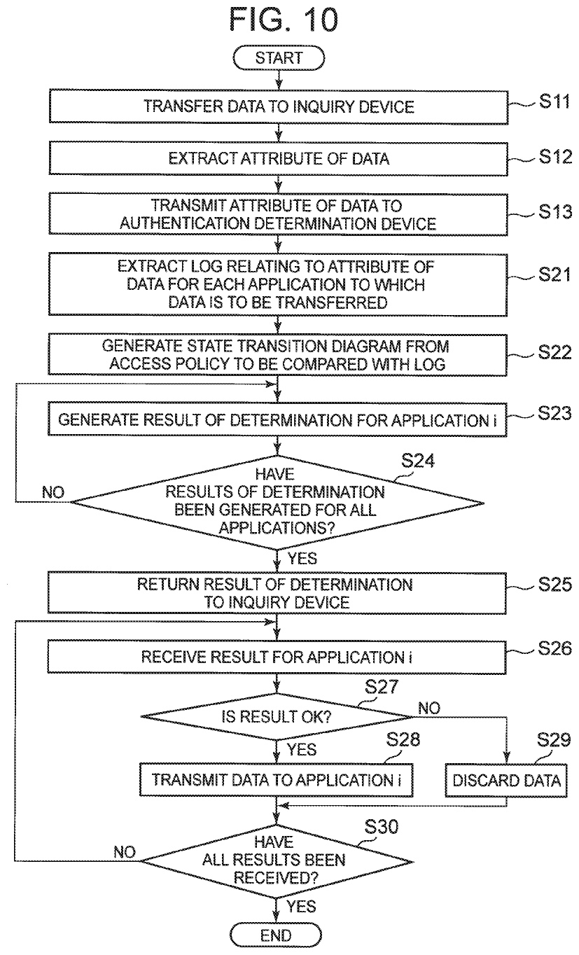

Next, the operation of the data control system according to the present exemplary embodiment will be described. FIG. 10 is a flowchart illustrating an operation example of a data control system 200 according to the second exemplary embodiment. The processing from transferring data to the inquiry device 21 by the device 11 to transmitting the attribute of the data extracted to the authentication determination device 52 by the inquiry device 21, that is, the processing from step S11 to step S13 is the same as the processing illustrated in FIG. 7.

When the application classification device 51 notifies the authentication determination device 52 of the attribute of the data for each received destination, the authentication determination device 52 extracts a log relating to the received attribute of the data, as a distribution history, from the log information storage unit 41, for each application to which the data is to be transferred (step S21). Note that, in step S21, in a case where data itself is caused to hold the log information of the data as the metadata, the authentication determination device 52 may identify the distribution history of the data from the log information.

The authentication determination device 52 compares the distribution history with the state transition diagram, and determines whether to transmit the data (step S22). The authentication determination device 52 generates a result of the determination for each application to which the data is to be transferred (step S23). When results of the determination are not generated for all applications (No in step S24), the processing of step S23 is repeated. On the other hand, when results of the determination are generated for all applications (Yes in step S24), the application classification device 51 returns the results of the determination to the inquiry device 21 (step S25).

The inquiry device 21 receives a result of the determination for each application to which the data is to be transferred (step S26). When the result of the determination represents permission of transmission of the data (Yes in step S27), the inquiry device 21 transmits the data to a destination (e.g., the application 30a) (step S28). On the other hand, when the result of the determination does not represent permission of transmission of the data (No in step S27), the inquiry device 21 discards the data (step S29). Note that, in step S29, the inquiry device 21 may transmit a response indicating that transmission of the data is not permitted to the device 11, instead of discarding the data.

The inquiry device 21 determines whether all results of the determination have been received (step S30). When not all results of the determination have been received (No in step S30), the processing is repeated from step S26. On the other hand, when all results of the determination have been received (Yes in step S30), the process ends.

As described above, in the present exemplary embodiment, when transmission data is transmitted to a plurality of destinations, the authentication determination device 52 determines whether to transmit data for each of the destinations. Therefore, in addition to the effects of the first exemplary embodiment, it is possible to control distribution according to the combination of destinations.

### Exemplary Embodiment 3

Next, a data control system according to a third exemplary embodiment of the present invention will be described. In the first exemplary embodiment and the second exemplary embodiment, the case where the device 10 or device 11 transmits one block of data has been described. In the present exemplary embodiment, a description is made on the assumption that a configuration has a plurality of blocks of data to be transmitted to the same destination.

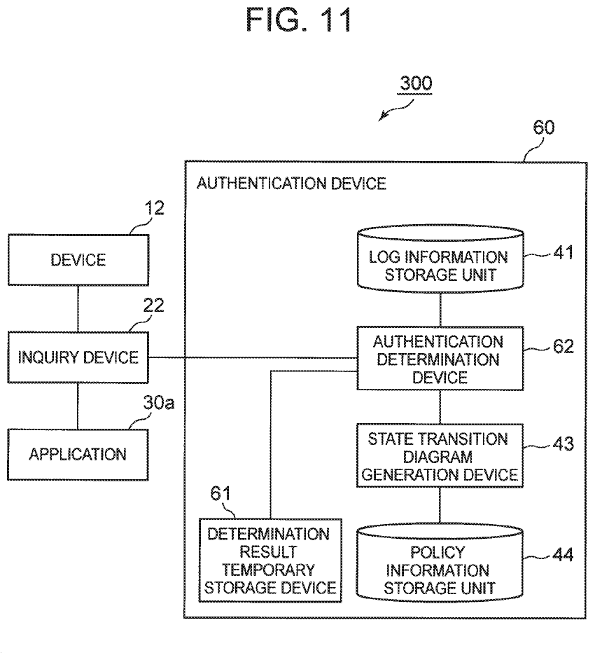

FIG. 11 is a block diagram illustrating a configuration example of the data control system according to a third exemplary embodiment of the present invention. A data control system 300 according to the present exemplary embodiment includes a device 12, an inquiry device 22, an application 30a, and an authentication device 60. The contents of the application 30a are the same as those in the first exemplary embodiment.

The device 12 transmits a plurality of blocks of data to be transmitted to the application 30a to the inquiry device 22. In other words, the device 12 makes a request for the inquiry device 22 to determine whether a plurality of blocks of data can be transmitted to the application 30a. As in the first and second exemplary embodiments, the device 12 may be a single device or part of another system (not illustrated). Furthermore, the device 12 may be a device that operates in response to a user's instruction.

The inquiry device 22 receives information indicating a destination (specifically, the application 30a) of the blocks of data together a plurality of blocks of data, from the device 12 that is a source. Then, the inquiry device 22 inquires of the authentication device 60 whether to transmit the plurality of the received blocks of data. Note that the content of transmission data at the time of the inquiry is the same as the content transmitted by the inquiry device 20 according to the first exemplary embodiment or the inquiry device 21 according to the second exemplary embodiment.

The inquiry device 22 determines whether transmission of data to the destination is permitted, according to a result of the determination from the authentication device 60 which is described later. The inquiry device 22 may transmit only data, transmission of which is determined to be permitted, or only when permission of transmission of all blocks of data is determined, all blocks of data may be transmitted to the destination.

The authentication device 60 includes a log information storage unit 41, an authentication determination device 62, a state transition diagram generation device 43, a policy information storage unit 44, and a determination result temporary storage device 61. The contents of the log information storage unit 41, the state transition diagram generation device 43, and the policy information storage unit 44 are the same as those in the first exemplary embodiment.

The determination result temporary storage device 61 is a storage device that temporarily stores results of determination about a plurality of blocks of data. The determination result temporary storage device 61 is achieved by, for example, a magnetic disk device.

The authentication determination device 62 determines, from a distribution history of each block of data to be transmitted, whether to transmit each block of data, based on an access policy. Note that a method of determining whether to transmit each block of data by the authentication determination device 62 is the same as the method performed by the authentication determination device 42 according to the first exemplary embodiment. Note that, in the present exemplary embodiment, the authentication determination device 62 stores a result of the determination in the determination result temporary storage device 61, each time a determination is made for each block of data. Then, when the determination for all blocks of data is completed, the authentication determination device 62 extracts the results of the determination stored in the determination result temporary storage device 61 and returns the results to the inquiry device 22.

Note that the inquiry device 22 and the authentication device 60 (more specifically, the authentication determination device 62 and the state transition diagram generation device 43) are achieved by a CPU of a computer that operates according to a program (data control program).

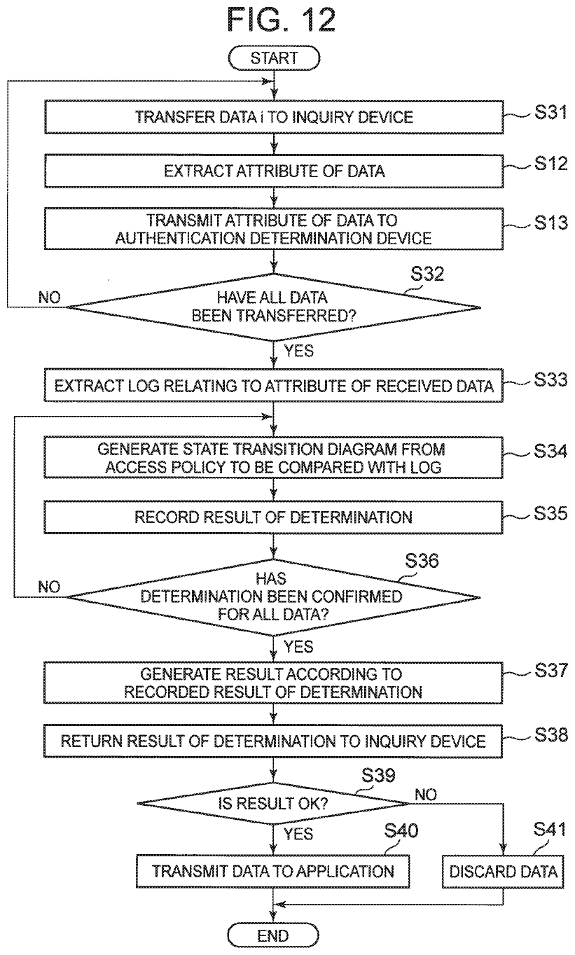

Next, the operation of the data control system according to the present exemplary embodiment will be described. FIG. 12 is a flowchart illustrating an operation example of the data control system 300 according to the third exemplary embodiment. The device 12 transfers each block of data to the inquiry device 22 (step S31). The processing of extracting attribute data received and transmitting the attribute data to the authentication determination device 62 by the device 12 is the same as the processing from step S12 to step S13 illustrated in FIG. 7.

The device 12 determines whether all blocks of data have been transferred (step S32). When not all blocks of data have been transferred (No in step S32), the processing is repeated from step S31. On the other hand, when all blocks of data have been transferred (Yes in step S32), the device 12 finishes transfer of the data. The authentication determination device 62 extracts a log relating to the received attribute of each block of data, as a distribution history, from the log information storage unit 41 (step S33). Note that, in step S33, in a case where data itself is caused to hold the log information of the data as the metadata, the authentication determination device 62 may identify the distribution history of the data from the log information.

The authentication determination device 62 compares the distribution history with the state transition diagram, and determines whether to transmit the data (step S34). The authentication determination device 62 records a result of the determination in the determination result temporary storage device 61 (step S35).

The authentication determination device 62 determines whether determination has been made for all blocks of data (step S36). When the determination has not been completed for all blocks of data (No in step S36), the processing is repeated from step S34. On the other hand, when the determination for all blocks of data has been completed (Yes in step S36), the authentication determination device 62 generates results according to the recorded results of the determination (step S37). Note that these results may be generated by the inquiry device 22. Then, the authentication determination device 62 returns the results of the determination to the inquiry device 22 (step S38).

The inquiry device 22 determines the contents of the results of the determination (step S39). When a result of the determination represents permission of transmission of a block of data (Yes in step S39), the inquiry device 22 transmits the block of data to the application 30a (step S40). On the other hand, when a result of the determination does not represent permission of transmission of a block of data (No in step S39), the inquiry device 22 discards the block of data (step S41). Note that, in step S41, the inquiry device 22 may transmit a response indicating that transmission of the block of data is not permitted to the device 12, instead of discarding the block of data.

As described above, in the present exemplary embodiment, the authentication determination device 62 determines whether to transmit each of blocks of data to the same destination. For example, when determining not to permit transmission of some data, the authentication determination device 62 determines not to permit transmission of all blocks of data. Therefore, in addition to the effects of the first exemplary embodiment, distribution can be controlled in consideration of a combination of blocks of data.

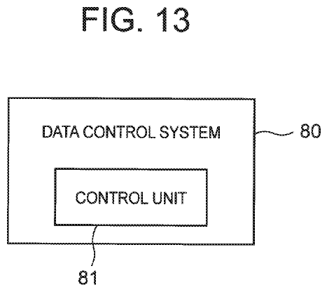

Next, the outline of the present invention will be described. FIG. 13 is a block diagram illustrating an outline of a data control system according to the present invention. A data control system 80 according to the present invention includes a control unit 81 (e.g., inquiry device 20, authentication device 40) that controls transmission of data from a source (e.g., device 10) to a destination (e.g., application 30a). The control unit 81 controls transmission of data to a destination based on a distribution history of transmission data.

With such a configuration, it is possible to control data to be safely distributed.

Furthermore, the control unit 81 may determine whether to transmit the data, from the distribution history of transmission data, based on an access policy that defines whether transmission to a destination can be performed for a distribution history.

Specifically, the control unit 81 may determine whether to transmit data, based on whether the distribution history of transmission data includes a distribution history matching the access policy.

Furthermore, permission or denial of transmission for a distribution history indicating that data is generated based on outputs from a plurality of components may be defined in an access policy. For example, the distribution history includes a distribution history showing components through which a plurality of blocks of data is calculated into one value. At this time, when transmission data is data having passed through the plurality of components, the control unit 81 may permit transmission of the data.

In addition, the data control system 80 may include an automaton generation unit (e.g., state transition diagram generation device 43) that generates an automaton (e.g., state transition diagram, state transition table) representing a distribution history defined by an access policy. The control unit 81 may solve a search problem on the automaton for a distribution history of data to determine whether the data includes a distribution history matching an access policy.

In addition, when transmission data is transmitted to a plurality of destinations, the control unit 81 may determine whether to transmit the data for each of the destinations.

In addition, the control unit 81 determines whether to transmit each of a plurality of blocks of data to be transmitted to the same destination and when determining not to permit transmission of some of the blocks of data, the control unit 81 may determine to permit no transmission of all of the blocks of data.

The part or whole of the exemplary embodiments disclosed above can be described as, but not limited to, the following supplementary notes.

### (Supplementary Note 1)

A data control system including a control unit that controls transmission of data from a source to a destination, in which the control unit controls transmission of data to the destination based on a distribution history of transmission data.

### (Supplementary Note 2)

The data control system according to supplementary note 1, in which the control unit determines whether to transmit the data, from the distribution history of the transmission data, based on an access policy that defines whether transmission to a destination is performed for the distribution history.

### (Supplementary Note 3)

The data control system according to supplementary note 2, in which the control unit determines whether to transmit the data, based on whether the distribution history of the transmission data includes a distribution history matching the access policy.

### (Supplementary Note 4)

The data control system according to supplementary note 2 or 3, in which permission or denial of transmission for a distribution history indicating that data is generated based on outputs from a plurality of components is defined in the access policy, and when transmission data is data having passed through the plurality of components, the control unit permits transmission of the data.

### (Supplementary Note 5)

The data control system according to any one of supplementary notes 2 to 4, further including an automaton generation unit that generates an automaton representing a distribution history defined by the access policy, in which the control unit solves a search problem on the automaton for a distribution history of data to determine whether the data includes a distribution history matching the access policy.

### (Supplementary Note 6)

The data control system according to any one of supplementary notes 1 to 5, in which when transmission data is transmitted to a plurality of destinations, the control unit determines whether to transmit the data for each of the destinations.

### (Supplementary Note 7)

The data control system according to any one of supplementary notes 1 to 6, in which the control unit determines whether to transmit each of a plurality of blocks of data to be transmitted to the same destination, and when determining not to permit transmission of some of the blocks of data, the control unit determines not to permit transmission of all of the blocks of data.

### (Supplementary Note 8)

A data control method including controlling transmission of data from a source to a destination based on a distribution history of transmission data.

### (Supplementary Note 9)

The data control method according to supplementary note 8, further including determining whether to transmit the data from the distribution history of the transmission data, based on an access policy that defines whether transmission to a destination is performed for the distribution history.

### (Supplementary Note 10)

A data control program causing a computer to: perform a control process of controlling transmission of data from a source to a destination; and control the transmission of data to the destination based on a distribution history of transmission data in the control process.

### (Supplementary Note 11)

The data control program according to supplementary note 10, further causing a computer to determine whether to transmit the data, from the distribution history of the transmission data, based on an access policy that defines whether transmission to a destination is performed for the distribution history, in the control process.

### REFERENCE SIGNS LIST

10 Device
20 Inquiry device
30a, 30b Application
40, 50, 60 Authentication device
41 Log information storage unit
42, 52, 62 Authentication determination device
43 State transition diagram generation device
44 Policy information storage unit
51 Application classification device
61 Determination result temporary storage device
100, 200, 300 Data control system

1. A data control system comprising
a hardware processor configured to execute a software code to control transmission of data from a source to a destination,
wherein the hardware processor is configured to execute the software code to control transmission of data to the destination based on a distribution history of transmission data.

2. The data control system according to claim 1, wherein
the hardware processor is configured to execute the software code to determine whether to transmit the data, from the distribution history of the transmission data, based on an access policy that defines whether transmission to a destination is performed for the distribution history.

3. The data control system according to claim 2, wherein
the hardware processor is configured to execute the software code to determine whether to transmit the data, based on whether the distribution history of the transmission data includes a distribution history matching the access policy.

4. The data control system according to claim 2, wherein
permission or denial of transmission for a distribution history indicating that data is generated based on outputs from a plurality of components is defined in the access policy, and
the hardware processor is configured to execute the software code to permit transmission of the data when transmission data is data having passed through the plurality of components.

5. The data control system according to claim 2,
wherein the hardware processor is configured to execute the software code to generate an automaton representing a distribution history defined by the access policy, and
solve a search problem on the automaton for a distribution history of data to determine whether the data includes a distribution history matching the access policy.

6. The data control system according to claim 1, wherein
the hardware processor is configured to execute the software code to determine whether to transmit the data for each of the destinations when transmission data is transmitted to a plurality of destinations.

7. The data control system according to claim 1, wherein
the hardware processor is configured to execute the software code to determine whether to transmit each of a plurality of blocks of data to be transmitted to the same destination, and
the hardware processor is configured to execute the software code to determine not to permit transmission of all of the blocks of data when determining not to permit transmission of some of the blocks of data.

8. A data control method comprising
controlling transmission of data from a source to a destination based on a distribution history of transmission data.

9. The data control method according to claim 8, further comprising
determining whether to transmit the data, from the distribution history of the transmission data, based on an access policy that defines whether transmission to a destination is performed for the distribution history.

10. A non-transitory computer readable information recording medium storing a data control program, when executed by a processor, that performs a method for:
controlling transmission of data from a source to a destination
based on a distribution history of transmission data.

11. The non-transitory computer readable information recording medium according to claim 10, further comprising
determining whether to transmit the data, from the distribution history of the transmission data, based on an access policy that defines whether transmission to a destination is performed for the distribution history.
